(19) United States
(12) Patent Application Publication
(10) Pub. No.: US 2018/0362758 A1
(43) Pub. Date: Dec. 20, 2018

(54) THERMOPLASTIC COMPOSITIONS FOR LASER DIRECT STRUCTURING AND METHODS FOR THE MANUFACTURE AND USE THEREOF

(71) Applicant: SABIC Global Technologies B.V., Bergen op Zoom (NL)

(72) Inventors: Tong WU, Shanghai (CN); Liang WEN, shanghai (CN); Anirban GANGULY, Bangalore (IN); Susanta MITRA, Bangalore (IN)

(21) Appl. No.: 16/061,565

(22) PCT Filed: Jun. 28, 2016
(86) PCT No.: PCT/IB2016/053851

§ 371 Date: Jun. 12, 2018

(30) Foreign Application Priority Data
Dec. 21, 2015 (IN) 4211/DEL/2015

(51) Int. Cl. C08L 69/00; B29B 7/88; B29C 45/00; C23C 18/20; C23C 18/16

(52) U.S. Cl. CPC C08L 69/00; B29B 7/88; B29C 45/0001; C23C 18/204; B29K 2069/00; C08L 2205/025; C08L 2205/035; C08L 2201/08; C08L 2201/02; C23C 18/1641

(57) ABSTRACT

The present disclosure relates to thermoplastic compositions. The disclosed compositions comprise at least one polycarbonate polymer, at least one polysiloxane-polycarbonate copolymer, at least one laser direct structuring additive, and low levels of at least one oligomeric siloxane additive, the composition exhibiting improved strength and electrical properties. Methods for making the disclosed thermoplastic compositions and the articles of manufacture comprising the disclosed thermoplastic compositions are also disclosed.

### CROSS REFERENCE TO RELATED APPLICATIONS

This application claims priority to Indian patent application no. 4211/DEL/2015 filed Dec. 21, 2015, the contents of which are incorporated by reference in their entirety.

### TECHNICAL FIELD

This disclosure relates to laser activatable polycarbonate compositions having improved mechanical and dielectric loss properties, methods of manufacture these compositions and the articles comprising the same.

### BACKGROUND

As electronic and electrical devices become increasingly smaller, there is a need for new materials that are thinner, stronger, antenna-favorable, and flame retardant and compatible with newer, more flexible manufacturing methods.

The present disclosure is directed to materials useful for laser-supported or directed structuring process (LDS) for 3D MIDs. The key challenges for this LDS technology include the development materials with robust plating performance, while maintaining good mechanical properties. Typically laser activatable additives lead to an impairment of the polymer matrix, which influences the material's impact strength. There is a critical need to balance appropriate additives and processing methods to counteract the decrease in mechanical strength from laser activatable additives/supporting materials acting carriers, and obtain the balance between LDS performance and mechanical, flammability, and electrical properties. The present disclosure is directed to addressing some of these concerns.

### SUMMARY

This disclosure includes compositions, each comprising: (a) at least one polycarbonate polymer, present in an amount in a range of from about 20 wt % to about 80 wt %; (b) at least one polysiloxane-polycarbonate copolymer, present in an amount in a range of from about 5 wt % to about 30 wt %; (c) at least one laser direct structuring additive, present in an amount in a range of from about 1 wt % to about 20 wt %; and (d) at least one oligomeric siloxane additive, present in an amount in a range of from above 0 wt % to about 10 wt %; wherein all weight percentages are provided relative to the weight of the entire composition.

In certain embodiments, the formed compositions exhibit at least one of the following properties: (a) a Notched Impact Strengths of at least 800 J/m at 23° C., or at least 400 J/m at −20° C,when tested according to ASTM D256; (b) a Notched Impact Strength that is at least 10% higher than otherwise identical compositions lacking the oligomeric siloxane additives; (c) a dissipation factor at 1.1 GHz of less than 0.0058, when tested according to ASTM D150; (d) a dissipation factor that is at least 10% lower than otherwise identical compositions lacking the oligomeric siloxane additives.

Still other embodiments provide methods for making these compositions, with steps including blending, molding, laser treating, and plating the compositions, and articles made from these processes.

### BRIEF DESCRIPTION OF THE DRAWINGS

The accompanying drawings, which are incorporated in and constitute a part of this specification, illustrate exemplary aspects and together with the description, serve to explain the principles of the compositions, methods and systems disclosed herein.

FIG. 1 shows a representative schematic diagram of compounding set-up.

FIG. 2 shows representative thermal, flexural, and tensile properties for representative disclosed compositions. Sample 11 also has a flexural modulus of 2.1 GPa and a tensile modulus of 2.12 GPa, while Sample 12 has a flexural modulus of 2.27 GPa and a tensile modulus of 2.3 GPa (where GPa are gigaPascals).

FIG. 3 shows representative melt flow rate, molecular weight, and Notched Izod Impact strength properties for representative disclosed compositions.

### DETAILED DESCRIPTION OF ILLUSTRATIVE EMBODIMENTS

Disclosed herein are polycarbonate compositions that exhibit good flame resistance, flexural modulus and stress, and improved notched impact strength and dielectric loss properties. The compositions comprises (a) at least one polycarbonate polymer, present in an amount in a range of from about 20 wt % to about 80 wt %; (b) at least one polysiloxane-polycarbonate copolymer, present in an amount in a range of from about 5 wt % to about 30 wt %; (c) at least one laser direct structuring additive, present in an amount in a range of from about 1 wt % to about 20 wt %; and (d) at least one oligomeric siloxane additive, present in an amount in a range of from above 0 wt % to about 10 wt %. The compositions display an advantageous combination of properties that render them useful in applications which are required for both data transfer and identification, e.g., automotive, healthcare, notebook personal computers, e-books, tablet personal computers, and the like. Disclosed herein also are methods of manufacturing the compositions and articles prepared therefrom. These are described below.

The present disclosure can be understood more readily by reference to the detailed description, examples, drawings, and claims described herein. It is to be understood that this disclosure is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

Those of ordinary skill in the relevant art will recognize and appreciate that changes and modifications can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. The following description is provided as illustrative of the principles of the present disclosure and not in limitation thereof. Various combinations of elements of this disclosure are encompassed by this disclosure, e.g. combinations of elements from dependent claims that depend upon the same independent claim.

Unless otherwise expressly stated, it is in no way intended that any method set forth herein be construed as necessarily requiring that its steps be performed in a specific order. Where a method claim does not specifically state in the claims or descriptions that the steps are to be limited to a specific order, it is no way intended that an order be inferred, in any respect.

All publications mentioned herein are incorporated herein by reference to describe the methods and/or materials in connection with which the publications are cited.

It is also to be understood that the terminology used herein is for the purpose of describing particular aspects only and is not intended to be limiting. As used in the specification and in the claims, the term “comprising” may include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more such polycarbonates. Furthermore, for example, reference to a filler includes mixtures of two or more such fillers.

The term “about” is intended to convey that similar values promote equivalent results or effected recited. Unless otherwise indicated or inferred, “about” means±5% of the nominal value. Other ranges may be inferred from context. Ranges can be expressed herein as from one particular value to another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” mean that the subsequently described condition, component, or circumstance may or may not occur, and that the description includes instances where said circumstance occurs and instances where it does not.

Unless otherwise specified, average molecular weights refer to weight average molecular weights (Mw) and percentages refer to weight percentages (wt %) which, unless specifically stated to the contrary, are based on the total weight of the composition in which the component is included. In all cases, where combinations of ranges are provided for a given composition, the combined value of all components does not exceed 100 wt %.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Component materials to be used to prepare disclosed compositions of the disclosure as well as the compositions themselves to be used within methods are disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, each and every combination and permutation of the compound and the modifications that are possible are contemplated unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure.

References in the specification and concluding claims to parts by weight, of a particular element or component in a composition or article denotes the weight relationship between the element or component and any other elements or components in the composition or article for which a part by weight is expressed. Thus, in a composition containing 2 parts by weight of component X and 5 parts by weight component Y, X and Y are present at a weight ratio of 2:5, and are present in such ratio regardless of whether additional components are contained in the compound.

Compounds disclosed herein are described using standard nomenclature. For example, any position not substituted by any indicated group is understood to have its valency filled by a bond as indicated, or a hydrogen atom.

The terms “alkyl” as used herein is a branched or unbranched saturated hydrocarbon group of 1 to 24 carbon atoms. The term “alkoxy” refers to an alkyl group bound through a single, terminal ether linkage. A “lower” alkyl or alkoxy group is one containing from one to six carbon atoms.

The terms “alkenyl group” and “alkynyl group” refers to a hydrocarbon group of from 2 to 24 carbon atoms and structural formula containing at least one carbon-carbon double or triple bond, respectively.

The term “aryl group” refers to any carbon-based aromatic group. The term “aromatic” includes both aryl and heteroaryl groups, the latter being defined as an aromatic group that has at least one heteroatom (e.g., N, O, S, or P) incorporated within the ring of the aromatic group.

As used herein, the terms “number average molecular weight” (“Mn”) and “weight average molecular weight” (“Mw”) are defined by the respective formulae:

$$Mn = \frac{Σ {N}_{i} {M}_{i}}{Σ {N}_{i}} , Mw = \frac{Σ {N}_{i} {M}_{i}^{2}}{Σ {N}_{i} {M}_{i}} ,$$

where Mᵢ is the molecular weight of a chain and Nᵢ is the number of chains of that molecular weight. Both Mn and Mw can be determined for polymers, such as polycarbonate polymers or polycarbonate-PMMA copolymers, by methods well known to a person having ordinary skill in the art.

Either or both Mn and Mw are measured gel permeation chromatography (“GPC”) and calibrated with polycarbonate standards. GPC can be carried out using a crosslinked styrene-divinyl benzene column, at a sample concentration of about 1 mg per mL with appropriate mobile phase solvents (e.g., methylene chloride or chloroform), and eluted at a flow rate of about 0.2 to 1.0 mL/min.

As used herein, the terms “polydispersity index” or “PDI” can be used interchangeably, having a value equal to or greater than 1, and are defined by the formula:

$$PDI = \frac{Mw}{Mn} .$$

The terms “polycarbonate” or “polycarbonates” as used herein includes copolycarbonates, homopolycarbonates and (co)polyester carbonates.

### I. Thermoplastic Compositions

The improved thermoplastic compositions described herein are particularly useful in connection with laser direct structuring (LDS) technology, providing enhanced plating performance while exhibiting relatively good mechanical properties. The disclosed thermoplastic compositions generally comprise a blend of a polycarbonate polymer component; a polysiloxane-polycarbonate copolymer component; a laser direct structuring additive; and an oligomeric siloxane additive; and may further optionally comprise one or more additional additives.

The disclosed thermoplastic compositions can exhibit, for example, improved mechanical, thermal, and/or morphological properties. Further, for example, the thermoplastic compositions may show either or both improved ductility and improved impact strength, without adversely affecting other mechanical and thermal properties.

According to aspects of the disclosure, a molded article formed from the disclosed thermoplastic compositions can exhibit a notched Izod impact energy at 23° C. in the range of from 800 to 1100 Joule/mole (J/m), including exemplary impact energy values in a range from 810-820 J/m, 820-830 J/m, 830-840 J/m, 840-850 J/m, 850-860 J/m, 860-870 J/m, 870-880 J/m, 880-890-, 890-900, 900-910, 910-920, 920-930, 930-940, 940-950, 950-960, 960-970, 970-980, 980-990, 990-1000, 1000-1100 J/m, or any combination of two or more of these ranges, for example, from 800 J/m to 1000 J/m or at least 800 or at least 850 J/m.

In further aspects, a molded article formed from a disclosed thermoplastic composition can exhibit a notched Izod impact energy at −23° C. or −20° c. in the range of from 400 J/m to 800 J/m, including exemplary impact energy values of 400-440 J/m, 440-480 J/m, 480-520 J/m, 520-560 J/m, 560-600 J/m, 600-640 J/m, 640-680 J/m, 680-720 J/m, 720-760 J/m, 760-800 J/m, or any combination of two or more of these ranges, derived from any two values set forth above, for example, 700 J/m to 800 J/m.

In another aspect, a molded article formed from a disclosed thermoplastic composition exhibits any combination of these notched Izod impact energies, e.g., exhibiting a notched Izod impact energy of at least 800 J/m at 23° C. and of at least 400 J/m at −20° C.

In still further aspects, molded articles formed from the disclosed thermoplastic compositions exhibit improved ductility. For example, a molded article formed from a disclosed thermoplastic composition can exhibit a % ductility of 100%, or at least 90%, or at least 80%, as measured according to ASTM D256-2010.

According to aspects of the disclosure, molded articles formed from the disclosed thermoplastic compositions can independently exhibit an improved tensile or flexural modulus. For example, the tensile modulus or flexural modulus can be independently in the range of from 1.0 to 3.0 gigaPascals (Gpa), including exemplary values of 1.1, 1.2, 1.3, 1.4, 1.5 GPa, 1.6, 1.7, 1.8, 1.9, 2.0, 2.1, 2.2, 2.3, 2.4, 2.5, 2.6, 2.7, 2.8, and 2.9 GPa, or in any range derived from any two of these value, e.g., from 2.0 to 3.0 GPa or from 2.1 to 2.5 GPa.

According to aspects of the disclosure, a molded article formed from the disclosed thermoplastic compositions can exhibit improved tensile strength. For example, the tensile strength can be in the range of from 30 to 50 megaPascals (Mpa), including exemplary tensile strengths of 31, 32, 33, 34, 35, 36, 37, 38 MPa, 39, 40 MPa, 41, 42, 43, 44, 45, 46, 47 MPa, 48, and 49 Mpa, or within any range of values derived from these values, for example, from 40 MPa to 50 MPa or from 40 MPa to 45 MPa.

In still further aspects, molded articles formed from the disclosed thermoplastic compositions can exhibit desirable values of percent elongation at break. In some aspects, a molded article formed from the disclosed compositions can exhibit elongations at break in the range of from 50% to 90%, including exemplary values of 50%, 52%, 54%, 56%, 58%, 60%, 62%, 64%, 66%, 68%, 70%, 72%, 74%, 76%, 78%, 80% 82%, 84%, 86%, 88%, and 90% or within any range derived from any two of these values, for example, from 50% to 70% or from 80% to 90%.

According to aspects of the disclosure, a molded article formed from the disclosed thermoplastic compositions can exhibit improved flexural strength. For example, the flexural strength can be in the range of from 60 MPa to 90 MPa, including exemplary flexural strengths of any unit value therebetween (e.g., 61, 62, 63, . . . 87, 8, 89), or any range of values derived from these unit values, e.g., from 70 MPa to 90 MPa, from 75 MPa to 90 MPa, or from 79 MPa to 90 MPa.

In still further aspects, molded articles formed from the disclosed thermoplastic compositions can exhibit desirable heat deflection temperatures (HDT). For example, a molded article formed from a disclosed thermoplastic composition can exhibit a heat deflection temperature in the range of from 90 to 150° C. or from 100 to 130° C., including 102, 104, 106, 108, 110, 112, 114, 116, 118, 120, 122, 124, 126, 128, or 130° C. In other aspects, a molded article formed from a disclosed thermoplastic composition can exhibit a heat deflection temperature in the range of from 110 to 120° C., e.g., 122° C., 123° C., 125° C., or 127° C.

In other aspects, molded articles formed from the disclosed thermoplastic compositions can exhibit dielectric constants at 1.1 GHz (gigahertz) of about 2.80, 2.82, 2.84, 2.86, 2.88. 2.90, 2.92, 2.94, 2.96, 2.98, or 3.00 or any range defined by these values. Similarly, the associated dielectric losses (dissipation factors) at 1.1 GHz may be less than 0.006 to about 0.0055 or 0.005, for example, 0.006, 0.0059, 0.0058, 0.0057, 0.0056, 0.0055, 0.0054, 0.0053, 0.0052, 0.0051, or 0.005, when tested according to ASTM D150.

A. Polycarbonate Polymer Component

The term polycarbonate as used herein is not intended to refer to only a specific polycarbonate or group of polycarbonates, but rather refers to the any one of the class of compounds containing a repeating chain of carbonate groups of the general formula (II) below:

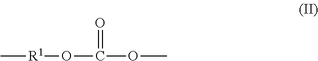

wherein at least 60 percent of the total number of R¹ groups comprise aromatic moieties and the balance thereof comprise aliphatic, alicyclic, or aromatic moieties

In one aspect, a polycarbonate material can include any one or more of those polycarbonate materials disclosed and described in U.S. Pat. No. 7,786,246, which is hereby incorporated by reference in its entirety for the specific purpose of disclosing various polycarbonate compositions and methods for manufacture of same.

In one aspect, a polycarbonate polymer component as disclosed herein can be an aliphatic-diol based polycarbonate. In another aspect, the polycarbonate polymer component can comprise a carbonate unit derived from a dihydroxy compound, such as, for example, a bisphenol that differs from the aliphatic diol.

The polycarbonate polymer component can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate.

Representative polycarbonates include those exemplified within this disclosure.

In certain aspects, the molecular weight of any particular polycarbonate can be determined by GPC, as described elsewhere herein, to have a weight average molecular weight (Mw), of greater than about 5,000 gram per mole (g/mol) or greater than or equal to about 20,000 g/mol. In other aspects, the polycarbonates have an Mw in a range of about 20,000 to 100,000 g/mol, including for example 30,000, 40,000, 50,000, 60,000, 70,000, 80,000, or 90,000 g/mol, in a range of about 22,000 to about 50,000 g/mol, or in a range of about 25,000 to 40,000 g/mol based on PS standards.

In some aspects, the glass transition temperature (Tg) of a polycarbonate can in a range of from 85° C. or 90° C. to a value less than or equal to a value of 160° C., of 150° C., of 145° C., of 140° C., of about 135° C., of 130° C., of 125° C., or of 120° C.

The polycarbonate can, in various aspects, be prepared by a melt polymerization process. Such processes are well known and need not be described here.

In an exemplary aspect, the polycarbonate polymer component comprises one or more bisphenol A polycarbonate polymers, including blends of at least two different grade bisphenol A polycarbonates. A polycarbonate grade can, for example, be characterized by the melt volume rate (MVR) of the polycarbonate. Exemplary bisphenol A polycarbonates can be characterized as having an MVR in the range of from 4 to 30 g/10 min, from 10 g/10 min to 25 g/10 min, from 15 g/10 min to 20 g/10 min, or from 4 g/10 min or 30 g/10 min at 300° C/1.2 kg.

The polycarbonate component can be present in the thermoplastic composition in any desired amount. For example, the polycarbonate polymer component can be present in an amount in the range of from about 5 wt % to about 85 wt %, including the exemplary amounts of 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, and 80 wt %, or within any range of amount derived from any two of the above states values, e.g., from 5-15 wt %, from 5-20 wt %, or from 50-85 wt %.

In aspects where the polycarbonate component comprises a blend of two or more polycarbonate polymers, it should be understood that each respect polycarbonate polymer present within the polycarbonate component can be present in any desired amount relative to the total weight percentage of the polycarbonate polymer component.

B. Polycarbonate-Polysiloxane Copolymer

The disclosed thermoplastic compositions further comprise a polycarbonate-polysiloxane block copolymer component. As used herein, the term polycarbonate-polysiloxane copolymer is equivalent to polysiloxane-polycarbonate copolymer, polycarbonate-polysiloxane polymer, or polysiloxane-polycarbonate polymer. The polysiloxane-polycarbonate copolymer comprises polydiorganosiloxane blocks comprising structural units of the general formula (I) below:

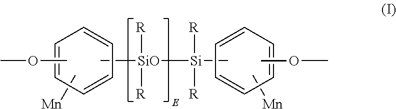

wherein the polydiorganosiloxane block length (E) is from about 20 to about 60; wherein each R group can be the same or different, and is selected from a C₁₋₁₃ monovalent organic group; wherein each M can be the same or different, and is selected from a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, and where each n is independently 0, 1, 2, 3, or 4.

Representative polycarbonate-polysiloxane copolymers include those exemplified within this specification.

In certain aspects the at least one polysiloxane-polycarbonate copolymer is present in an amount in a range bounded at the lower end by a value of from about 5, 6, 7, 8, 9, 10 wt %, 12, 14, 16, 18, or about 20 wt % and at the upper end by a value of about 40, 35 wt %, 30, 25 wt %, 20, 18, 16, 14, 12, or about 10 wt %.

In some aspects, two or more polysiloxane-polycarbonate copolymers may be used. For example, in some embodiments, blends of end-capped and hydroxy terminated materials may be used. In other embodiments, blends of similar chemistries having different proportions of siloxane may also be used. In some aspects, the polysiloxane-polycarbonate copolymers include those described by Chemical Abstract Service No. 202483-49-6 and 156064-99-2. In related embodiments, these two types of polysiloxane-polycarbonate copolymers may be present with respect to one another (i.e., CAS 202483-49-6 to CAS 156064-99-2) in a ratio ranging from about 1:1 to about 2:1.

In some aspects, at least one of the polysiloxane-polycarbonate copolymers comprises siloxane in a range bounded at the lower end by a value of from about 2 wt %, 4 wt %, 6 wt %, 8 wt %, or 10 wt % and at the upper end by a value of about 30 wt %, to about 28 wt %, to about 26 wt %, to about 24 wt %, 22 wt %, 20 wt %, 18 wt %, 16 wt %, 14 wt %, 12 wt %, or about 10 wt %, relative to the total weight of the polysiloxane-polycarbonate copolymer. The siloxane groups may be arranged randomly or in block arrangement within the polysiloxane-polycarbonate copolymer.

According to exemplary non-limiting aspects of the disclosure, the polycarbonate-polysiloxane block copolymer comprises diorganopolysiloxane blocks of the general formula (III) below:

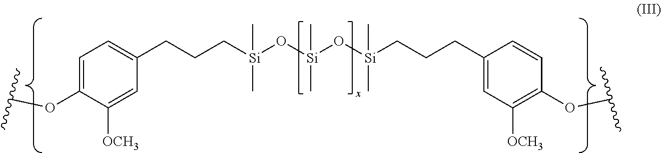

wherein x represents an integer from about 20 to about 60. The polycarbonate blocks according to these aspects can be derived from bisphenol-A monomers.

Diorganopolysiloxane blocks of formula (III) above can be derived from the corresponding dihydroxy compound of formulae (IV) or (V):

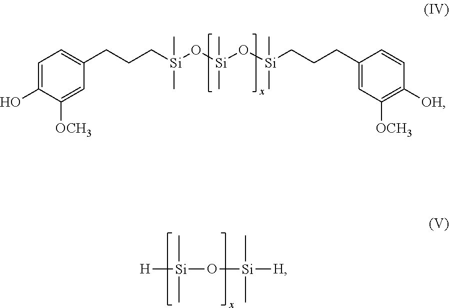

wherein x is as described above.

Other copolymers or blends of copolymers include those comprising polycarbonate (PC) and polydimethylsiloxane (PDMS), having a structure according to:

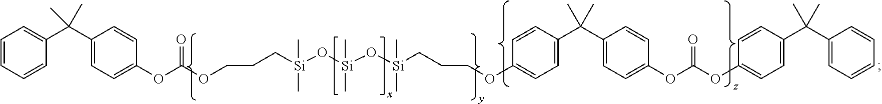

i.e., comprising polysiloxane polybisphenol A carbonate blocks. In some embodiments, the copolymers may comprise polysiloxane in a range of 2 to 30 wt %, relative to the weight of the entire copolymer. In other embodiments, the polysiloxane content in the copolymer or copolymer blend is in a wt % range of from about 2 to 4, 4 to 6, 6 to 8, 8 to 10, 10 to 12, 12 to 14, 14 to 16, 16 to 18, 18 to 20, 20 to 22, 22 to 24, 24 to 26, 26 to 28, or from 28 wt % to 30 wt %, or any combination thereof. In exemplary embodiments, e.g., the polycarbonate/polydimethylsiloxane content is provided as a blend of copolymers, one having a polysiloxane content in a range of from about 4 to about 10 wt % (e.g., C9030T) and a second having a polysiloxane content in a range of from about 16 to about 24 wt % (e.g., C9030P).

In some of these embodiments, the polycarbonate/polydimethylsiloxane copolymers segregate into a domain structure, in which the polysiloxane domains are sized in a range of about 1 nm to about 5 nm (nanometer), from about 5 nm to 10 nm, from about 10 nm to about 15 nm, from about 10 nm to about 15 nm, from about 15 nm to about 20 nm, from about 20 nm to about 25 nm, from about 25 nm to about 30 nm, 30 nm to 50 nm, from about 50 nm to about 100 nm, from about 100 nm to about 250 nm, from about 250 nm to about 500 nm, from about 500 nm to about 750 nm, from about 750 nm to about 1 micron, from about 1 micron to about 5 micron, from about 5 micron to about 10 micron, from about 10 micron to about 15 micron, from about 15 micron to about 20 micron, from about 20 micron to about 25 micron, from about 25 micron to about 30 micron or any combination thereof.

Non-limiting examples of polycarbonate-siloxane copolymers include transparent and “opaque” EXL, available from SABIC Innovative Plastics. The transparent EXL from SABIC is a polycarbonate-polysiloxane (C9030T) copolymer, having been tested commercially and found to have about 6 mole % siloxane, a Mw of about 44,600, a Mn of about 17800 in a polystyrene standard using chloroform solvent, and exhibiting siloxane domains sized in a range of from about 5 nm to about 15 nm. The MVR of this material has been found to be 300 C/1.2 kg, of about 10 cm³/10 min. The “opaque” EXL from SABIC is a bisphenol A polycarbonate-polysiloxane (C9030P) copolymer, endcapped with paracumyl phenol, having been tested commercially and found to have about 20 mole % siloxane, a Mw of about 28500-30000 grams per mole, an MVR at 300 C/1.2 kg, of about 7 cm³/10 min, and exhibiting siloxane domains sized in a range of from about 5 micron to 20 microns.

According to aspects of the disclosure, the polysiloxane-polycarbonate block copolymer can be provided having any desired level of siloxane content. In independent aspects, the siloxane content can be in the range of from 4 mole % to 20 mole %,from 4 mole % to 10 mole %, from 4 mole % to 8 mole, and from 5 to 7 mole wt %, about 6 mole %. The diorganopolysiloxane blocks can be randomly distributed in the polysiloxane-polycarbonate block copolymer.

The disclosed polysiloxane-polycarbonate block copolymers can also be end-capped. For example, according to aspects of the disclosure, a polysiloxane-polycarbonate block copolymer can be end capped with p-cumyl-phenol.

The polysiloxane polycarbonate copolymer component can be present in the thermoplastic composition in any desired amount within the ranges prescribed herein, including exemplary amounts of 5, 10, 15, 20, 25, or 30 wt %, or within any range bounded by these values.

C. Laser Direct Structuring Additive

The disclosed thermoplastic compositions further comprise a conventional laser direct structuring additive (LDS) additive, selected such that, after activating with a laser, a conductive path can be formed by a subsequent standard metallization or plating process—i.e., when the LDS additive is exposed to a laser, elemental metal is released or activated which act as nuclei for the crystal growth during a subsequent metallization or plating process, such as a copper plating, gold plating, nickel plating, silver plating, zinc plating, tin plating or the like.

Representative LDS additives include those exemplified within the Examples and the Aspect section of this specification. Exemplary and non-limiting examples of commercially available laser direct structuring additives include PK3095 black pigment, commercially available from Ferro Corp., USA. The PK3095, for example, comprises chromium oxides (Cr₂O₃, Cr₂O₄²⁻, Cr₂O₇²⁻) and oxides of copper (CuO), as determined using XPS. The PK3095 black pigment also has a spinel type crystal structure. Another exemplary commercially available laser direct structuring additive is the Black 1G pigment black 28 commercially available from The Shepherd Color company. The Black 1G pigment black 28 comprises copper chromate and has a pH of about 7.3. The Black 1G pigment also has a spinel type crystal structure.

In some aspects, at least one laser direct structuring additive is present in an amount in the composition in a range having a lower boundary of about 1, 2, 3, 4, 5, 6, 7, 8, 9, 10, or 15 wt % and an upper boundary of about 20, 15, 10, 9, 8, 7, or 6 wt %, e.g., in a range of from 7 to 12 wt %, from 9 to 14 wt %, or an amount of about 10 wt %.

D. Oligomeric Siloxane Additive

The disclosed thermoplastic compositions further comprise at least one oligomeric siloxane additive. While conventional laser direct structuring additives can be detrimental to the base thermoplastic resin composition, and adversely affect its properties, the presence of the siloxane additive mitigates these adverse effects providing thermoplastic compositions that are suitable for use in laser direct structuring while also maintaining or exhibiting desired performance properties.

According to aspects of the disclosure, the oligomeric siloxane additive may modify the surface pH of the LDS additive, or together, the siloxane and LDS additives may alter the surface pH of the filler composition. In another aspect, the filler composition comprises an amino siloxane additive and a copper chromate oxide that forms a chemical bond.

In some aspects, the siloxane additive is added directly during the extrusion process along with the polycarbonate polymer, the polysiloxane-polycarbonate copolymer, the laser direct structuring additive, and any additional ingredients. In other aspects, the laser direct structuring additive may be pre-treated with a siloxane additive. Alternatively, the laser direct structuring additive may be treated with a coupling agent and/or compatibilizer and then be fed into the extrusion as the second step of the process. Either modification process or extrusion process may, for example, be performed at room temperature or 23° C.

The siloxane additive can be polymeric or oligomeric in nature or, alternatively, can be monomeric or a single compound. The at least one filler composition comprises at least one siloxane additive. The at least one siloxane additive may, for example, comprise functional groups selected from amino groups, phenyl groups, and epoxy groups. Non-limiting examples of siloxane additives may include epoxysilane, aminosilane, aminosiloxane, or phenylsiloxane. In one aspect, the siloxane additive comprises an aminosiloxane. In another aspect, the siloxane additive comprises a phenyl siloxane.

Representative siloxane oligomers may, but not necessarily exhibit, viscosities in a range of from about 20 cSt to about 80 cSt, preferably from about 25 to about 60 cSt at a temperature in the range of 20° C. to 25° C. Representative viscosities are shown in the Examples

The siloxane additive can be an aminosiloxane such as an amodimethicone silsequioxane or a mixture comprising an amodimethicone silsequioxane. As used herein, “amodimethicone” refers to amine-functionalized silicone. For example, polydimethylsiloxane (dimethicone, by INCI naming standards), consists of methyl groups (—CH₃) as the pendant group along the backbone of the polymer chain. Amine-functionalized silicones have been chemically modified so that some of the pendant groups along the backbone have been replaced with various alkylamine groups (-alkyl-NH₂). In various aspects, the aminosiloxane can comprise about 60 wt % to about 90 wt % of a mixture of siloxanes and silicones, including dimethyl polymers with methyl silsequioxanes and about 10 wt % to about 30 wt % aminofunctional oligosiloxane. One suitable aminosiloxane mixture comprising an amodimethicone silsequioxane is SF-1706, which is commercially available from Momentive Performance Materials, USA. Another suitable aminosiloxane is a 25/75 mixture of methoxy terminated aminoethylaminopropyl polysiloxane and methoxy terminated siloxane resin.

In one aspect, the aminosiloxane can comprise one or more oligomeric or polymeric siloxane compounds having a structure represented by the formula:

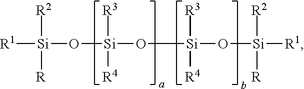

wherein each occurrence of R and R² is a substituted or unsubstituted group independently selected from alkyl, aryl, olefinic (vinyl), and —OR⁵; wherein each occurrence of R¹ is independently selected from a substituted or unsubstituted group selected from alkyl, aryl, olefinic (vinyl), —OR⁴, and a diamino group containing the radical —F¹—NR⁶—F—NH₂, with the proviso that at least one R¹ group is a diamino containing radical; wherein F¹ 1 is a linear or branched alkylene of 1-12 carbon atoms; F is linear or branched alkylene of 2-10 carbon atoms; wherein each occurrence of R³ and R⁴ is independently selected from substituted or unsubstituted alkyl, aryl, capped or uncapped polyoxyalkylene, alkaryl, aralkylene or alkenyl; wherein each occurrence of R⁵is independently hydrogen or alkyl; wherein each occurrence of R⁶ is independently hydrogen or lower alkyl; wherein a is an integer from 0 to 10,000; and wherein b is an integer from 10 to 1000, with the proviso that a and b are present in a ratio of a:b of at least 1:1 to 200:1.

In independent aspects, at least one of the oligomeric siloxane additives comprises a polymethyl-polysiloxane, a polyphenyl-polysiloxane, or a combination thereof. In some aspects, at least one of the oligomeric siloxane additives comprises a polymethyl-polyphenyl-polysiloxane having a plurality of dimethyl siloxyl or diphenyl siloxyl repeating units. At least one of the oligomeric siloxane additives can be a hydroxy terminated silicone fluid. In other aspects, at least one of the oligomeric siloxane additives is terminated by trimethyl silyl groups.

In various aspects, the aminosiloxane can be a mixture comprising a compound having a structure represented by the formula:

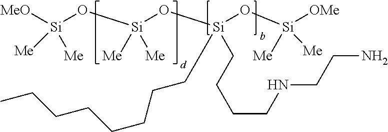

The aminosiloxane can also be a curable amine functional silicone such as the commercially available curable amine functional silicones Dow Corning Silicone 531 and 536, and SWS Silicones Corp. SWS E-210. Other suitable curable amino functional silicones are also sold by Wacker, Siltech Corporation, and others. The terms “amine functional silicone,” “aminosiloxane,” and “aminoalkylsiloxane” are synonymous and are used interchangeably in the literature. The term “amine” as used herein means any suitable amine, and particularly cycloamine, polyamine and alkylamine, which include the curable alkylmonoamine, alkyldiamine and alkyltriamine functional silicones.

Particularly useful siloxane additives are represented by the structures:

The siloxane additive can comprise a commercially available silicone such as SFR-100 (aka F33094) or SF1023 (Momentive Performance Materials) or EC4952 silicone (Emerson Cummings Co., USA). SFR-100 silicone is characterized as a silanol- or trimethylsilyl-terminated polymethylsiloxane and is a liquid blend comprising about 60-80 weight percent of a difunctional polydimethylsiloxane having a number-average molecular weight of about 150,000, and 20-40 wt percent of a polytrimethylsilyl silicate resin having monofunctional (i.e. trimethylsiloxane) and tetrafunctional (i.e. SiO₂) repeating units in an average ratio of between about 0.8 and 1 to 1 and having a number-average molecular weight of about 2,200. EC4952 silicone is characterized as a silanol-terminated polymethylsiloxane having about 85 mole percent of difunctional dimethylsiloxane repeating units, about 15 mole percent of trifunctional methylsiloxane repeating units and having a number-average molecular weight of about 21,000. Other polyfunctional poly(C₁₋₆ alkyl)siloxane polymers which can be used are disclosed in U.S. Pat. Nos. 4,387,176 and 4,536,529, the disclosures of which are hereby incorporated by reference. In some aspects, the siloxane additive comprises a phenylsiloxane, for example, may be commercially available as phenyl-containing siloxane fluid, called SE 4029 from Momentive Performance Materials, USA.

In some aspects, at least one oligomeric siloxane additive is present in an amount in a range having a lower boundary of about 0.1, 0.2, 0.3, 0.4, 0.5, 0.6, 0.7, 0.8, 0.9, 1. 1.1, 1.2, 1.3, 1.4, 1.5, 2, 3, or 4 wt % and having an upper boundary of about 10, 9, 8, 7, 6, or 5 wt %. Any combination of these values may define ranges considered within the scope of this disclosure (e.g., from 0.2 to 5 wt % or from 4 to 9 wt %).

E. Optional Thermoplastic Composition Additives

The disclosed thermoplastic compositions can optionally comprise one or more additives conventionally used in the manufacture of molded thermoplastic parts with the proviso that the optional additives do not adversely affect the desired properties of the resulting composition. Mixtures of optional additives can also be used. Such additives may be mixed at a suitable time during the mixing of the components for forming the composite mixture. For example, the disclosed compositions can comprise one or more fillers, plasticizers, stabilizers, anti-static agents, flame-retardants, impact modifiers, colorant, antioxidant, and/or mold release agents. In one aspect, the composition further comprises one or more optional additives selected from an antioxidant, flame retardant, inorganic filler, and stabilizer.

Exemplary heat stabilizers include, for example, organo phosphites; phosphonates; phosphates, or combinations including at least one of the foregoing heat stabilizers. Heat stabilizers are generally used in amounts of from 0.01 to 0.5 parts by weight based on 100 parts by weight of the total composition, excluding any filler.

Exemplary antioxidants include, for example, organophosphites; alkylated monophenols or polyphenols; alkylated reaction products of polyphenols with dienes; butylated reaction products of para-cresol or dicyclopentadiene; alkylated hydroquinones; hydroxylated thiodiphenyl ethers; alkylidene-bisphenols; benzyl compounds; amides or esters of beta-(3,5-di-tert-butyl-4-hydroxyphenyl)-propionic acid; esters of beta-(5-tert-butyl-4-hydroxy-3-methylphenyl)-propionic acid with monohydric or polyhydric alcohols; esters of thioalkyl or thioaryl compounds; or combinations including at least one of the foregoing antioxidants. Antioxidants are generally used in amounts of from 0.01 to 0.5 parts by weight, based on 100 parts by weight of the total composition, excluding any filler.

The disclosed thermoplastic compositions can further comprise an optional filler, such as, for example, an inorganic filler or reinforcing agent. The specific composition of filler, if present, can vary, provided that the filler is chemically compatible with the remaining components of the thermoplastic composition. In one aspect, the thermoplastic composition comprises a mineral filler such as talc.

In another aspect, an exemplary filler can comprise metal silicates and silica powders; boron-containing; oxides of Al, Mg, or Ti; anhydrous or hydrated calcium sulfate; wollastonite; hollow and/or solid glass spheres; kaolin; single crystal metallic or inorganic fibers or “whiskers”; glass or carbon fibers (including continuous and chopped fibers, including flat glass fibers), sulfides of Mo or Zn; barium compounds; metals and metal oxides; flaked fillers; fibrous fillers; short inorganic fibers reinforcing organic fibrous fillers formed from organic polymers capable of forming fibers (e.g., PEEK, PEI, PTFE, PPS); and fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Exemplary light stabilizers include, for example, benzotriazoles, 2-(2-hydroxy-5-tert-octylphenyl)-benzotriazole and 2-hydroxy-4-n-octoxy benzophenone or a combination thereof. Light stabilizers are generally used in amounts of from 0.1 to 1.0 parts by weight, based on 100 parts by weight of the total composition, excluding any filler.

Exemplary plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any filler.

Exemplary antistatic agents include, for example, glycerol monostearate, sodium stearyl sulfonate, sodium dodecylbenzenesulfonate or the like, or combinations of the foregoing antistatic agents. In one aspect, carbon fibers, carbon nanofibers, carbon nanotubes, carbon black, or any combination of the foregoing may be used in a polymeric resin containing chemical antistatic agents to render the composition electrostatically dissipative.

Exemplary mold releasing agents or lubricants include for example stearates (including metal or alkyl stearates) or waxes. When used, mold releasing agents are generally used in amounts of from 0.1 to 1.0 parts by weight, or from 0.1 to 5 parts by weight based on 100 parts by weight of the total composition, excluding any filler.

The disclosed thermoplastic compositions can optionally further comprises a flame retardant additive. Where present, the flame retardant additive can comprise one or more phosphate-containing or a halogen-containing material. In other aspects, the flame retardant additive is free of or substantially free of one or more of phosphate and/or a halogen. The term “substantially free” connotes a presence of an ingredient less than 0.05 wt %. The flame retardant additive may comprise an oligomer organophosphorous flame retardant (e.g., bisphenol A diphenyl phosphate (BPADP)). In a further aspect, the flame retardant is selected from oligomeric or polymeric phosphate, oligomeric phosphonate, or mixed phosphate/phosphonate ester compositions. The flame retardant may be selected from triphenyl phosphate; cresyldiphenylphosphate; tri(isopropylphenyl)phosphate; resorcinol bis(diphenylphosphate); and bisphenol-A bis(diphenyl phosphate). In a yet further aspect, the flame retardant is bisphenol-A bis(diphenyl phosphate). The concentration of a flame retardant additive can vary, and the present disclosure is not intended to be limited to any particular flame retardant concentration. In one aspect, the disclosed composition can comprises from greater than 0% to about 20 wt % of flame retardant additive, including for example, about 0.5, 1, 2, 3, 4, 5, 6, 7, 8, 9, 10, 11, 12, 13, 14, 15, 16, 17, 18, or 19 weight %, or any value within a range bounded or defined by two of these values, for example from 0.5 to 1 wt %, from 5 to 15 wt %, or from 10 to 20 wt %, based on weight of total composition excluding filler. Flame retardant additives are generally commercially available.

Additionally, materials to improve flow and other properties may be added to the composition, such as low molecular weight hydrocarbon resins. Particularly useful classes of low molecular weight hydrocarbon resins are those derived from petroleum C₅ to C₉ feedstock that are derived from unsaturated C₅ to C₉ monomers obtained from petroleum cracking, for example C₅₋₁₂ olefins or diolefins or aromatic hydrocarbons

Methods of Manufacture

In one aspect, the method comprises forming a molded part from the formed blend composition. In another aspect, the method further comprises subjecting the molded part to a laser direct structuring process.

In a further aspect, the disclosure relates to a method for making the thermoplastic compositions described herein, the method comprising forming a blended composition comprising: (a) polycarbonate polymer; (b) a polysiloxane-polycarbonate copolymer; (c) a laser direct structuring additive; and (d) a siloxane additive.

In another aspect, the method involves three steps: 1) injection molding, 2) laser structuring, and optionally 3) metallizing the laser structured composition.

In a further aspect, during the injection molding step, the laser direct structuring additive and siloxane additive may be mixed with the polycarbonate polymer and the polysiloxane-polycarbonate copolymer. In another aspect, the blend composition further comprises one or more optional additives selected from an antioxidant, flame retardant, inorganic filler, and stabilizer. In a still further aspect, single shot injection molding can be used to produce the parts or articles to be laser structured. In at least one aspect, the thermoplastic composition may be mixed at this step and used in the LDS process. In another aspect, additional ingredients may be added to the thermoplastic composition after this step.

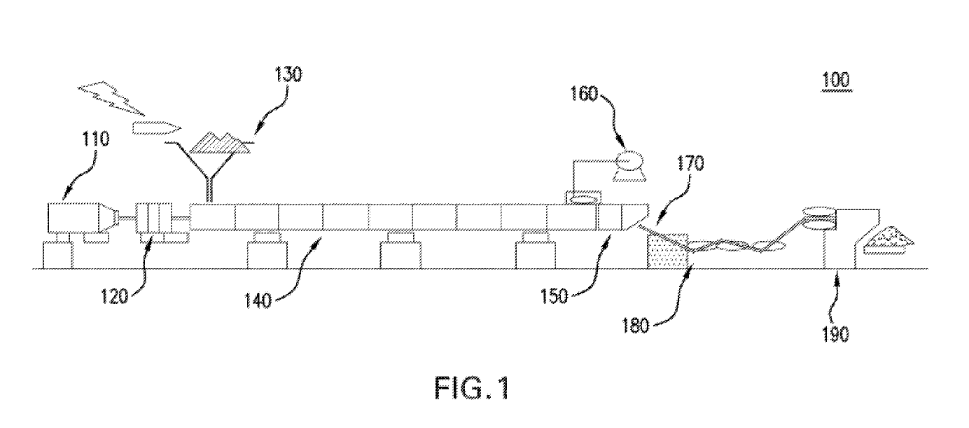

The polycarbonate compositions can be manufactured by various methods known in the art (see, e.g., FIG. 1). For example, powdered polycarbonate, and other optional components are first blended, optionally with any fillers, in a high speed mixer or by hand mixing. The blend is then fed into the throat of a twin-screw extruder via a hopper. Alternatively, at least one of the components can be incorporated into the composition by feeding it directly into the extruder at the throat and/or downstream through a side stuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

In a further aspect, during the laser structuring step, a laser is used to form a conductive path during the laser structuring step. The laser structuring step may comprise laser direct structuring or laser etching. In a further aspect, laser etching is carried out to provide an activated surface. In a further aspect, at least one laser beam draws at least one pattern on the surface of the thermoplastic composition during the laser structuring step. In another aspect, the employed filler composition may release at least one metallic nucleus. The at least one metallic nucleus that has been released may act as a catalyst for reductive copper (or other metal) plating process.

The laser etching is carried out at about 1 Watt to about 10 Watt power with (a) a frequency from about 30 kHz to about 110 kHz and a speed of about 1 meters oer second (m/s) to about 5 m/s; or (b) a frequency from about 40 kHz to about 100 kHz and a speed of about 2 m/s to about 4 m/s. In another aspect, laser etching is carried out at about 3.5 Watt power with a frequency of about 40 kHz and a speed of about 2 m/s.

In a further aspect, the LDS process may result in formation of a rough surface. The rough surface may entangle the copper plate with the polymer matrix in the thermoplastic composition providing adhesion between the copper plate and the thermoplastic composition.

The metallizing step can, in various aspects, be performed using conventional electroless or electrolytic plating techniques (e.g., using an electroless copper plating bath). In a still further aspect, the metallization can comprise the steps: a) cleaning the etched surface; b) additive build-up of tracks; and c) plating.

In one aspect, the formed blend composition comprises: (a) a bisphenol A polycarbonate polymer; (b) a polysiloxane-polycarbonate block copolymer comprising diorganopolysiloxane blocks of the general formula (VII):

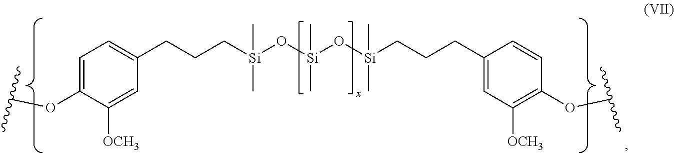

wherein x is from about 40 to about 60; and polycarbonate blocks are derived from bisphenol-A monomers; wherein the diorganopolysiloxane blocks are randomly distributed in the polysiloxane-polycarbonate block copolymer; wherein the siloxane content of the polysiloxane-polycarbonate block copolymer ranges from 4 mole % to 20 mole %; (c) a laser direct structuring additive; and (d) an oligomeric siloxane additive; wherein the molded article formed from the composition exhibits a notched Izod impact energy at 23° C. of at least 500 J/m and a notched Izod impact energy at -23° C. of at least 300 J/m.

Articles of Manufacture

Shaped, formed, or molded articles including the thermoplastic compositions are also provided. The thermoplastic compositions can be molded into useful shaped articles by a variety of means such as injection molding, extrusion, rotational molding, blow molding and thermoforming to form articles such as, for example, personal computers, notebook and portable computers, cell phone antennas and other such communications equipment, medical applications, RFID applications, automotive applications, and the like.

The blended thermoplastic compositions, or compounds, disclosed herein provide robust plating performance while maintaining good mechanical properties, for example, a notched Izod impact energy at 23° C. or at −20° C. as described elsewhere herein. Evaluation of the mechanical properties can be performed through various tests, such as Izod test, Charpy test, Gardner test, etc., according to several standards (e.g., ASTM D256). Unless specified to the contrary, all test standards described herein refer to the most recent standard in effect at the time of filing of this application.

In one aspect, the molded article formed from the composition exhibits ductile failure mode according to ASTM D256-2010.

In several aspects, the LDS compounds include a fixed loading amount of an LDS additive, such as copper chromium oxide, and varying amounts of thermoplastic base resins. In such aspects, fixed loading amounts of a stabilizer, an antioxidant, and a mold release agent were maintained in the LDS compounds.

In one aspect, the article comprises the product of extrusion molding or injection molding a composition comprising: (a) at least one polycarbonate polymer, present in an amount in a range of from about 20 wt % to about 80 wt %; (b) at least one polysiloxane-polycarbonate copolymer, present in an amount in a range of from about 5 wt % to about 30 wt %; (c) at least one laser direct structuring additive, present in an amount in a range of from about 1 wt % to about 20 wt %; and (d)at least one oligomeric siloxane additive, present in an amount in a range of from above 0 wt % to about 10 wt %; or any of the other compositions cited herein, wherein all weight percentages are provided relative to the weight of the entire composition.

In a further aspect, the molded article further comprises a conductive path formed by activation with a laser. In a yet further aspect, the article further comprises a metal layer plated onto the conductive path. In an even further aspect, the metal layer is a copper layer. In a still further aspect, the metal layer has a thickness of about 0.8 micrometers or higher as measured according to ASTM B568.

In various aspects, the thermoplastic composition may be used in the field of electronics. In a further aspect, non-limiting examples of fields which may use 3D MIDs, LDS process, or thermoplastic composition include electrical, electro-mechanical, Radio Frequency (RF) technology, telecommunication, automotive, aviation, medical, sensor, military, and security.

In one aspect, molded articles according to the present disclosure can be used to produce a device in one or more of the foregoing fields. Such devices which may use 3D MIDs, LDS processes, or thermoplastic compositions according to the present disclosure include, for example, computer devices, household appliances, decoration devices, electromagnetic interference devices, printed circuits, Wi-Fi devices, Bluetooth devices, GPS devices, cellular antenna devices, smart phone devices, automotive devices, military devices, aerospace devices, medical devices, such as hearing aids, sensor devices, security devices, shielding devices, RF antenna devices, or RFID devices.

Other non-limiting examples of such devices in the automotive field include adaptive cruise control, headlight sensors, windshield wiper sensors, door/window switches,pressure and flow sensors for engine management, air conditioning, crash detection, and exterior lighting fixtures.

In one aspect, the molded articles may have a thickness ranging from 1.2 mm to 2.0 mm. For example, the molded article may have a thickness of 1.6 mm. In further aspect, the molded article may have a thickness ranging from 2.8 to 3.5 mm. For example, the molded article may have a thickness of 3.2 mm. As used herein, “mm” refers to millimeter.

In a further aspect, the resulting disclosed compositions can be used to provide any desired shaped, formed, or molded articles. For example, the disclosed compositions may be molded into useful shaped articles by a variety of means such as injection molding, extrusion, rotational molding, blow molding and thermoforming. As noted above, the disclosed compositions are particularly well suited for use in the manufacture of electronic components and devices. As such, according to some aspects, the disclosed compositions can be used to form articles such as printed circuit board carriers, burn in test sockets, flex brackets for hard disk drives, and the like.

The following listing of Aspects complements the previous descriptions:

Aspect 1. A thermoplastic composition comprising:

(a) at least one polycarbonate polymer, present in an amount in a range of from about 20 wt % to about 80 wt %, relative to the weight of the entire composition;

(b) at least one polysiloxane-polycarbonate copolymer, present in an amount in a range of from about 5 wt % to about 30 wt %, relative to the weight of the entire composition;

(c) at least one laser direct structuring additive, present in an amount in a range of from about 1 wt % to about 20 wt %, relative to the weight of the entire composition; and

(d) at least one oligomeric siloxane additive, present in an amount in a range of from above 0 wt % to about 10 wt %, relative to the weight of the entire composition.

Aspect 2. The thermoplastic composition of Aspect 1, wherein the at least one polycarbonate polymer is present in an amount in a range of from about 30 wt %, from about 35 wt %, from about 40 wt %, from about 45 wt %, from about 50 wt %, from about 55 wt %, or from about 60 wt %, to about 80 wt %, to about 75 wt %, to about 70 wt %, to about 65 wt %, to about 60 wt %, to about 55 wt %, or to about 50 wt %, relative to the weight of the entire composition.

Aspect 3. The thermoplastic composition of Aspect 1 or 2, wherein the at least one polysiloxane-polycarbonate copolymer is present in an amount in a range of from about 5 wt %, from about 6 wt %, from about 7 wt %, from about 8 wt %, from about 9 wt %, from about 10 wt %, from about 12 wt %, from about 14 wt %, from about 16 wt %, from about 18 wt %, or from about 20 wt % to about 30 wt %, to about 25 wt %, to about 20 wt %, to about 18 wt %, to about 16 wt %, to about 14 wt %, to about 12 wt %, or to about 10 wt %, relative to the weight of the entire composition.

Aspect 4. The thermoplastic composition of any one of Aspects 1 to 3, comprising a first and second polysiloxane-polycarbonate copolymer present in a ratio of first to second in a range of from 2:5 to 1:1, wherein the first polysiloxane-polycarbonate copolymer comprises about 16 to about 24 wt % polysiloxane, relative to the entire weight of the first polysiloxane-polycarbonate copolymer and the second polysiloxane-polycarbonate copolymer comprises about 4 to about 10 wt % polysiloxane, relative to the entire weight of the second polysiloxane-polycarbonate copolymer

Aspect 5. The thermoplastic composition of any one of Aspects 1 to 4, wherein the at least one laser direct structuring additive is present in an amount in a range of from about 1 wt %, from about 2 wt %, from about 3 wt %, from about 4 wt %, from about 5 wt %, from about 6 wt %, from about 7 wt %, from about 8 wt %, from about 9 wt %, from about 10 wt %, or from about 15 wt % to about 20 wt %, to about 15 wt %, to about 10 wt %, to about 9 wt %, to about 8 wt %, to about 6 wt %, or to about 6 wt %, relative to the weight of the entire composition.

Aspect 6. The thermoplastic composition of any one of Aspects 1 to 5, wherein the at least one oligomeric siloxane additive is present in an amount in a range of from about 0.1 wt %, from about 0.2 wt %, from about 0.3 wt %, from about 0.4 wt %, from about 0.5 wt %, from about 0.6 wt %, from about 0.7 wt %, from about 0.8 wt %, from about 0.9 wt %, from about 1.0 wt %, from about 1.1 wt %, from about 1.2 wt %, from about 1.3 wt %, from about 1.4 wt %, from about 1.5 wt %, from about 1 wt %, from about 2 wt %, from about 3 wt %, or from about 4 wt % to about 10 wt %, to about 9 wt %, to about 8 wt %, to about 7 wt %, to about 6 wt %, or to about 5 wt %, relative to the weight of the entire composition.

Aspect 7. The thermoplastic composition of any one of Aspects 1 to 6, wherein at least one of the polycarbonate polymer is a bisphenol A polycarbonate polymer.

Aspect 8. The thermoplastic composition of any one of Aspects 1 to7, wherein at least one of the polycarbonate polymer is a bisphenol A polycarbonate polymer made by a melt process.

Aspect 9. The thermoplastic composition of of any one of Aspects 1 to 8, wherein the at least one polycarbonate polymer comprises a blend of at least two different bisphenol A polycarbonates.

Aspect 10. The thermoplastic composition of any one of Aspects 1 to 9, wherein at least one of the polysiloxane-polycarbonate copolymers comprises siloxane in a range of from about 2 wt %, 4 wt %, 6 wt %, 8 wt %, or 10 wt % to about 30 wt %, to about 28 wt %, to about 26 wt %, to about 24 wt %, to about 22 wt %, to about 20 wt %, to about 18 wt %, to about 16 wt %, to about 14 wt %, to about 12 wt %, to about 10 wt %, relative to the total weight of the polysiloxane-polycarbonate copolymer.

Aspect 11. The thermoplastic composition of any one of Aspects 1 to 10, wherein at least one of the laser direct structuring additives comprises a heavy metal mixture oxide spinel, a copper salt, or a combination thereof.

Aspect 12. The thermoplastic composition of any one of Aspects 1 to 10, wherein the laser direct structuring additive comprises a copper chromium oxide spinel, a copper salt, a copper hydroxide phosphate, a copper phosphate, a copper sulfate, a cuprous thiocyanate, a spinel based metal oxide, a copper chromium oxide, an organic metal complex, a palladium/palladium-containing heavy metal complex, a metal oxide, a metal oxide-coated filler, antimony doped tin oxide coated on mica, a copper containing metal oxide, a zinc containing metal oxide, a tin containing metal oxide, a magnesium containing metal oxide, an aluminum containing metal oxide, a gold containing metal oxide, a silver containing metal oxide, or a combination thereof, preferably a copper chromium oxide spinel.

Aspect 13. The thermoplastic composition of any one of Aspects 1 to 12, wherein at least one of the oligomeric siloxane additives comprises a polyamino-polysiloxane.

Aspect 14. The thermoplastic composition of any one of Aspects 1 to 13, wherein at least one of the oligomeric siloxane additives comprises a polymethyl-polysiloxane

Aspect 15. The thermoplastic composition of any one of Aspects 1 to 14, wherein at least one of the oligomeric siloxane additives comprises a polyphenyl-polysiloxane.

Aspect 16. The thermoplastic composition of any one of Aspects 1 to 15, wherein at least one of the oligomeric siloxane additives comprises a polymethyl-polyphenyl-polysiloxane having a plurality of repeating units:

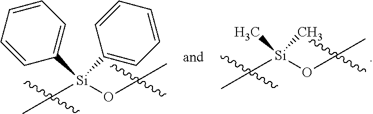

Aspect 17. The thermoplastic composition of any one of Aspects 1 to 16, wherein at least one of the oligomeric siloxane additives is a hydroxy terminated silicone fluid.

Aspect 18. The thermoplastic composition of any one of Aspects 1 to 17, wherein at least one of the oligomeric siloxane additives is terminated by trymethyl silyl groups.

Aspect 19. The thermoplastic composition of any one of Aspects 1 to 18, further comprising one or more optional additives selected from an antioxidant, flame retardant, inorganic filler, and stabilizer.

Aspect 20. The thermoplastic composition of any one of Aspects 1 to 19, exhibiting a Notched Impact Strength at 23° C. of at least 800 J/m, at least 850 J/m, or at least about 900 J/m (up to about 1100 J/m), or any value or range of values cited herein for this feature, when tested according to ASTM D256.

Aspect 21. The thermoplastic composition of any one of Aspects 1 to 20, exhibiting a Notched Impact Strength at −20° C. of at least 400 J/m, at least 500 J/m, at least 600 J/m, or at least about 700 J/m (up to about 800 J/m), or any value or range of values cited herein for this feature, when tested according to ASTM D256.

Aspect 22. The thermoplastic composition of any one of Aspects 1 to 21, wherein the exhibited Notched Impact Strength at either −20° C. or 23° C. or both −20° C. and 23° C. is at least 10% higher than the Notched Impact Strength of the otherwise identical material but lacking the at least one oligomeric siloxane additive, when tested under the same conditions according to ASTM D256.

Aspect 23. The thermoplastic composition of any one of Aspects 1 to 22, exhibiting a dissipation factor at 1.1 GHz is less than 0.006 or less than 0.0058, when tested according to ASTM D150.

Aspect 24. The thermoplastic composition of any one of Aspects 1 to 23, wherein the exhibited dissipation factor at 1.1 GHz is at least 10% less than the dissipation factor at 1.1 GHz of the otherwise identical material but lacking the at least one oligomeric siloxane additive, when tested under the same conditions according to ASTM D150.

Aspect 25. The thermoplastic composition of any one of Aspects 1 to 24 comprising:

(a) at least one bisphenol A polycarbonate polymer, present in an amount in a range of from about 70 wt % to about 80 wt %;

(b) at least one polysiloxane-polycarbonate copolymer, present in an amount in a range of from about 5 wt % to about 15 wt %;

(c) at least one laser direct structuring additive, present in an amount in a range of from about 4 wt % to about 10 wt %; and

(d) at least one oligomeric siloxane additive, present in an amount in a range of from 0.1 wt % to about 2 wt %;

wherein all weight percentages are provided relative to the weight of the entire composition.

Aspect 26. The thermoplastic composition of Aspect 25, comprising a first and second polysiloxane-polycarbonate copolymer present in a ratio of first to second in a range of from 2:5 to 1:1, wherein the first polysiloxane-polycarbonate copolymer comprises about 16 to about 24 wt % polysiloxane, relative to the entire weight of the first polysiloxane-polycarbonate copolymer and the second polysiloxane-polycarbonate copolymer comprises about 4 to about 10 wt % polysiloxane, relative to the entire weight of the second polysiloxane-polycarbonate copolymer

Aspect 27. The thermoplastic composition of any one of Aspects 1 to 26, further comprising a plated surface.

Aspect 28. A method for making a thermoplastic composition; comprising forming a blend composition comprising:

(a) at least one polycarbonate polymer, present in an amount in a range of from about 20 wt % to about 80 wt %, relative to the weight of the entire composition;

(b) at least one polysiloxane-polycarbonate copolymer, present in an amount in a range of from about 5 wt % to about 30 wt %%, relative to the weight of the entire composition;

(c) at least one laser direct structuring additive, present in an amount in a range of from about 1 wt % to about 20 wt %%, relative to the weight of the entire composition; and

(d) at least one oligomeric siloxane additive, present in an amount in a range of from above 0 wt % to about 10 wt %%, relative to the weight of the entire composition;

under conditions so as to produce a composition of any one of Aspects 1 to 27.

Aspect 29. The method of Aspect 28, wherein the blend composition is formed by extrusion blending.

Aspect 30. The method of Aspect 28 or 29, further comprising forming a molded part from the formed blend composition.

Aspect 31. The method of any one of Aspects 28 to 30, further comprising subjecting the molded part to a laser direct structuring process.

Aspect 32. The method of Aspect 31, further comprising plating the laser structured molded composition.

Aspect 33. An article manufactured from the composition of any one of Aspects 28 to 32, the composition having been laser direct structured.

Aspect 34. An article manufactured from the composition of Aspect 33, the composition having been electrolessly plated.

### EXAMPLES

The following examples are put forth so as to provide those of ordinary skill in the art with a complete disclosure and description of how the methods, devices, and systems disclosed and claimed herein are made and evaluated, and are intended to be purely exemplary and are not intended to limit the disclosure. Best efforts have been made to ensure accuracy with respect to numbers (e.g., amounts, temperature, etc.), but some errors and deviations should be accounted for. Unless indicated otherwise, parts are parts by weight, temperature is in degrees Celsius (° C.) or is at ambient temperature, and pressure is at or near atmospheric.

### Example 1

### Experimental Series One

### Example 1.1

### General Materials and Methods

For the non-limiting Examples described herein below, sample compositions were prepared from the components described in Table 1 below. The Example compositions (labeled as “Example 1,” “Example 2,” and the like) and various comparator samples (labeled as “Comp. 1,” “Comp. 2,” and the like) are further described herein. Molded articles were prepared for analysis.

TABLE 1

| Iden- | | |
|---|---|---|
| tifier | Description | Source |
| PC1 | BPA polycarbonate resin made by a melt process | SABIC |
| | SABIC Innovative with an MVR of 23.5-28.5 g/10 | Inno- |
| | min at 300° C./1.2 kg. | vative |
| | | Plastics |
| | | (“SABIC |
| | | IP”) |
| PC2 | BPA polycarbonate resin made by a melt process | SABIC |
| | SABIC IP with an MVR of 5.1-6.9 g/10 min at 300° | IP |
| | C./1.2 kg. | |
| PC3 | 100 Grade PCP | SABIC |
| | | IP |
| PC4 | PC Resin 1300 with end-capped PCP | SABIC |
| | | IP |
| PC/PS | Polycarbonate-siloxane copolymer comprising about 6 | SABIC |
| | mole percent siloxane with a Mw of 44658, Mn of | IP |
| | 17850. The Mw and Mn are as determined by gel | |
| | permeation chromatography (“GPC”) using | |
| | polystyrene standard and chloroform as the mobile | |
| | phase | |
| PETS | Pentraerythritol tetrastearate | Merc |
| LDS1 | Black copper chromium oxide spinel;. Ferro | Ferro |
| | Corporation (Tradename: Pigment Black PK 3095) | Corp. |
| LDS2 | Black copper chromium oxide spinel. (Tradename: | The |
| | Black 1G). | Shepherd |
| | | Color |
| | | Company |
| AO1 | Pentaerythritol tetrakis(3-(3,5-di-tert-butyl-4- | Ciba |
| | hydroxyphenyl)propionate) which is a sterically | Special- |
| | hindered phenolic antioxidant. (Tradename: | ty Chemi- |
| | Irganox ™ 1010) | cals |
| | | (“CIBA”) |
| AO2 | 1,2-bis(3,5-di-tert-butyl-4- | Mayzo |
| | hydroxyhydrocinnamoyl)hydrazine, a sterically | |
| | hindered phenol antioxidant. (Tradename: BNX ™ | |
| | MD1024) | |
| AO3 | Tris (2,4-di-tert-butylphenyl)phosphite, a trisaryl | CIBA |
| | phosphite antioxidant (Tradename: Irgafos ™ 168) | |
| AO4 | Octadecyl-3-(3,5-di-tert.butyl-4-hydroxyphenyl)- | CIBA |
| | propionate which is a sterically hindered phenolic | |
| | antioxidant (Tradename: Irganox ™ 1076) | |
| UV1 | 2-(2-Hydroxy-5-t-octylphenyl) benzotriazole, a UV | — |
| | stabilizer | |
| ZI | Zinc ionomer comprising a hydrophilic copolymer of | Merc |
| | ethylene and acrylic acids; with a molecular weight of | |
| | 1,000 to 3,000, a melting point of about 99° C.; and an | |
| | acid number of nil. (Tradename: AClyn ™ 295) | |
| FIL | Aluminosilicate filler. (Tradename: Talc HT S0.5) | Luzenac |
| PA | Phosphoric acid, 45% aqueous solution | — |
| PAE | Phosphoric acid ester (Phosphonous acid, P,P′-[[1,1′- | — |
| | biphenyl]-4,4′-diyl]bis-,P,P,P′,P′-tetrakis[2,4-bis(1,1- | |
| | dimethylethyl)phenyl] ester) | |
| ZP | Mono zinc phosphate | — |
| SO1 | 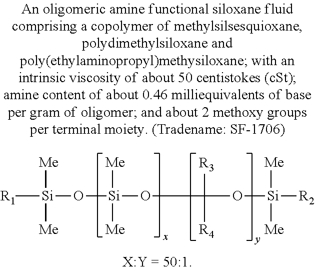 | Momen- tive Per- formance Materials (“Momen- tive”) |
| SO2 | A phenyl-containing siloxane fluid comprising | Momen- |
| | polydimethylsiloxane having terminal methoxy | tive |
| | groups; phenyl groups having about 50-55 weight | |
| | percent of Si(Ph₂)O groups wherein “Ph” denotes a | |
| | phenyl group; and a viscosity at 23° C. of 32-60 | |
| | centistokes. (Tradename: SE 4029) | |
| SO3 | A high viscous silicone fluid comprising a silanol | Momen- |
| | stopped methylsiloxane polymer silicone base. | tive |
| | (Tradename: SFR-100) | |

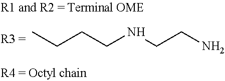

Molded articles were prepared for analysis as described herein, and in FIG. 1 (compounding set-up). FIG. 1 includes (100) a motor, (120) a gear box, (130) a vibrator feeder, (140) an extruder, (150) a die hard, (160) a vacuum pump, (170) strands, (180) a water bath, and (190) a pelletizer. The raw materials for sample batches were weighted and mixed in a high-speed mixer at about 1000-3000 rpm for about 120 sec. prepared by pre-blending all constituents in a dry-blend and tumble mixing for about 4-6 minutes. All samples were prepared by melt extrusion by feeding the pre-blend into a W&P ZSK2 Twin Screw Extruder with co-rotating twin screw (25 mm) with a 10-barrel set-up and a length to diameter ratio of 40, using a barrel temperature of about 260° C. to about 280° C., and a screw speed kept at about 300 rpm with the torque value maintained from about 50% to about 60%, and operated under standard processing conditions well known to one skilled in the art. After extrusion, the pellets were dried at about 100° C. for a minimum time of four hours prior to molding test samples. The molding process was carried out with a temperature profile of 260° C. to 280° C. with an injection speed of about 5-70 mm/min and an injection pressure of about 60-70 bar, with the mold temperature maintained at 80° C.

Heat deflection temperature was determined per ISO 75 with flatwise specimen orientation with specimen dimensions of 80 mm×10 mm×4 mm Data were collected using a Ceast HDT VICAT instrument and are provided below in units of ° C.

The notched Izod impact (“NII”) test was carried out on 80 mm×10 mm×4 mm molded samples (bars) according to ISO180 at 23° C. Test samples were conditioned in ASTM standard conditions of 23° C. and 55% relative humidity for 48 hours and then were evaluated. NII was determined using a Ceast Impact Tester.

Flexural properties (modulus and strength) were measured using 3.2 mm bars in accordance with ISO 178. Flexural strength (in units of MPa) and flexural modulus (in units of GPa) are reported at yield.

Melt volume-flow rate (“MVR”) was determined according to standard ISO 1133 under the following test conditions: 300° C./1.2 kg load/1080 sec dwell time. Data below are provided for MVR in cm³/10 min (i.e., cubic centimeters per 10 minutes).

Tensile properties (modulus, strength, and strength at yield) were measured on 3.2 mm bars in accordance with ISO 527 using sample bars prepared in accordance with ISO 3167 Type 1A multipurpose specimen standards. Tensile strength (for either at break or at yield, in units of MPa), tensile modulus (ion units of gigaPascals, GPa), and tensile elongation (%) are reported at break.

### Example 1.2

### Comparison of Different Siloxane Additives

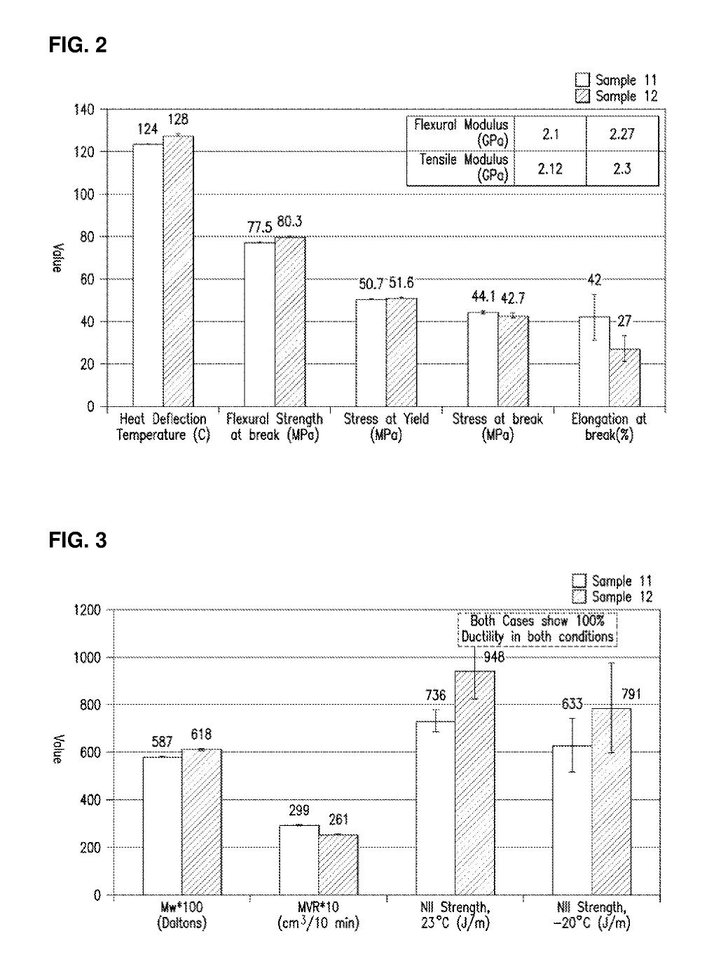

The siloxane additives SO1 (Tradename: SF-1076) and SO3 (Tradename: SFR-100) were directly compared to one another in a formulation comprising Cu—Cr spinel (LDS2). The formulation composition is described in Table 2. Mechanical and thermal properties for the two compositions are shown in FIG. 2 and FIG. 3. The Y-axis in each figure do not have unit measurements associated, which are specified for the particular property for each pair of bar graphs below the X-axis. The data in FIG. 2 show that both Sample 11 and 12 displayed similar HDT, tensile properties, and flexural properties. In addition, both samples displayed similar retention of molecular weight when both SO1 and SO3 were used, and there was no apparent difference in MVR values under the test conditions used (FIG. 3). Room temperature (23° C.) and sub-zero temperature (−20° C.) NII strength test results (FIG. 3) show retention of 100% ductility under both conditions for compositions comprising either siloxane additives. The sample composition, Sample 12, comprising SO3 imparts comparatively more improvement in NII reaching a maximum value as high as almost 950 J/m as shown in FIG. 3 (with a higher standard deviation also) as compared to ca. 730 J/m for Sample 11 comprising SOI. Low temperature NII results show that both the additives are about equally good in retaining NH strength.

TABLE 2

| No. | Item | Sample 11 | Sample 12 |
|---|---|---|---|
| 1 | PC3 | 53.43 | 53.43 |
| 2 | PC4 | 17.6 | 17.6 |
| 3 | PC/PS | 15 | 15 |
| 4 | PETS | 0.05 | 0.05 |
| 5 | LDS1 | — | — |
| 6 | LDS2 | 10 | 10 |
| 7 | AO1 | 0.1 | 0.1 |
| 8 | AO2 | 0.06 | 0.06 |
| 9 | AO3 | 0.1 | 0.1 |
| 10 | ZI | — | — |
| 11 | FIL | 3 | 3 |
| 12 | PA | — | — |
| 13 | PAE | — | — |
| 14 | SO1 | 2 | — |
| 15 | SO2 | — | — |
| 16 | SO3 | — | 2 |
| 17 | AO4 | 0.10 | 0.10 |
| 18 | UV1 | 0.12 | 0.12 |
| 19 | ZP | 0.1 | 0.1 |
| Total | | 100 | 100.5 |

* Amounts provided in terms of wt % of total composition

### Example 2

### Experimental Series Two

The base resin used in this study was a combination of majority of polycarbonate—PC105, PC175 and polycarbonate-siloxane copolymer. The Laser Direct Structuring additives used in this study include Copper Chromate of Spinel structure (Cu—Cr Spinel) and Copper Hydroxide Phosphate. The raw materials used and their suppliers are listed in Table 3.

TABLE 3

| No. | Chemical Ingredient | Description | Source |
|---|---|---|---|
| 1 | PCP 1300, CAS: 111211-39-3 | Base resin | SABIC IP |
| 2 | 100 Grade PCP, CAS: 111211-39-3 | Base resin | SABIC IP |
| 3 | 20% PC/Siloxane copolymer endcapped, | Impact | SABIC IP |
| | CAS: 202483-49-6 | modifier | |
| 4 | Transparent PC-Siloxane Co-polymer, CAS: | Impact | SABIC IP |
| | 156064-99-2 | modifier | |
| 5 | Copper hydroxide phosphate, CAS: 12158-74-6 | Functional | Merck |
| | | filler | |
| 6 | Shepherd Black 1G, CAS: 68186-91-4 | Functional | The Shepherd Color |
| | | filler | Company |
| 7 | Phosphite Stabilizer, CAS: 31570-04-4 | Antioxidant | BASF |
| | | agent | |
| 8 | Hindered Phenol Stabilizer, CAS: 6683-19-8 | Antioxidant | BASF |
| | | agent | |
| 9 | Phosphorous acid ester, CAS: 386-77-3 | Antioxidant | Clariant |
| | | agent | |
| 10 | Hindered Phenol Anti-oxidant, CAS: 002082-79-3 | Antioxidant | CIBA |
| | | agent | |
| 11 | Pentaerythritol Tetrastearate, CAS: 115-83-3 | Release agent | FACI |
| 12 | 2-(2′Hydroxy-5-T-Octylphenyl)-Benzotriazole, | Stabilizer | BASF |
| | CAS: 3147-75-9 | | |
| 13 | Mono Zinc Phosphate (MZZP), CAS: 13598-37-3 | Stabilizer | Budenheim |
| 14 | ADR 4368 (cesa 9900), CAS: 100-42-5 | Chain extender | BASF |
| 15 | Fine Talc, CAS: 14807-96-6, 1318-59-8, 14808- | Inorganic filler | Luzenac Fine Talc |
| | 60-7, 16389-88-1 | | |
| 16 | Coated TiO₂, CAS: 13463-67-7 | Inorganic filler | Kronos |
| 17 | MD1024, CAS: 032687-78-8 | Metal | BASF |
| | | deactivator | |

The structure of oligomeric siloxane additive used in this study can be seen below:

For reactivity with OH groups on the filler and LDS additive surface: SFR100>SF-1023.

The formulations all contain primary antioxidant and secondary antioxidants that are well known to those known in the arts.

### Example 2.1

### Processing and Testing

All samples were prepared by melt extrusion on a Toshiba Twin screw extruder, using different melt temperature and RPM according to different base resin. Table 4 lists the compounding profile and equipment set up.

TABLE 4
Compounding profile of polycarbonate composites
using TEM-37BS Compounder

| Parameters | Units | Value |
|---|---|---|
| Barrel size | millimeter (mm) | 1500 |
| Die | mm | 3 |
| Zone 1 Temp | degree Celsius (° C.) | 250 |
| Zone 2 Temp | ° C. | 250 |
| Zone 3 Temp | ° C. | 250 |
| Zone 4 Temp | ° C. | 250 |
| Zone 5 Temp | ° C. | 260 |
| Zone 6 Temp | ° C. | 260 |
| Zone 7 Temp | ° C. | 260 |
| Zone 8 Temp | ° C. | 260 |
| Zone 9 Temp | ° C. | 260 |
| Zone 10 Temp | ° C. | 260 |
| Zone 11 Temp | ° C. | 260 |
| Zone 12 Temp | ° C. | 260 |
| Die Temp | ° C. | 260 |
| Screw Speed | revolutions per minute (rpm) | 300 |
| Throughput | kilogram/hour (kg/hr) | 25 |
| Vacuum | megaPascals (MPa) | −0.08 |

The molding process was carried out in a range of from 260 to 280° C. with an injection speed of 50 to 70 mm/min, and an injection pressure of 60 to 70 bar. The mold temperature was kept at 80° C. Table 5 lists the molding profile.

TABLE 5
Molding profile of polycarbonate composites

| Parameters | Units | Values |
|---|---|---|
| Pre-drying time | Hours | 3 |
| Pre-drying temperature | ° C. | 100 |
| Hopper temperature | ° C. | 70 |
| Zone 1 temp | ° C. | 270 |
| Zone 2 temp | ° C. | 280 |
| Zone 3 temp | ° C. | 285 |
| Nozzle temp | ° C. | 285 |
| Mold temp | ° C. | 80 |
| Screw speed | ° C. | 80 |
| Back pressure | kilogram force/square centimeter | 30 |
| | (kgf/cm²) | |
| Cooling time | seconds (sec) | 20 |
| Injection speed | millimeter per second (mm/s) | 100 |
| Holding pressure | kgf/cm² | 800 |
| Max. injection pressure | kgf/cm² | 1200 |

Tests were all conducted in accordance with ASTM, ISO standards, according to: MVR (ASTM D1238); Density (ISO 1183); Notched Izod (ASTM D 256); Tensile testing, 5 mm/min (ASTM D638); Flexural testing, 1.27 mm/min (ASTM D790); HDT, 1.82 MPa, 3.2 mm thickness bar (ASTM D 648); Dielectric constant and dielectric loss (ASTM D 150).

### Example 2.2

### Results

Table 6 illustrates the mechanical properties of the investigated compositions. Based on core grade DX11354X formula with 6% of TiO₂, it was found that with the addition of 1% SFR100, the notched impact strength under room temperature increased from 763 J/m to 933 J/m. And more compelling, the notched impact strength under low temperature (−20° C.) increased sharply from 246 J/m to 795 J/m. Such low temperature performance is quite comparable to EXL1414 level, which is superlative unfilled grade in mobile phone area. The addition of SF1023 showed the similar trend. Also the increase of elongation at break was found with the addition of 1% SFR100 or SF1023, which means improved material ductility.

More important, from dielectric test one promising trend was found. With the addition of 1% SFR100 or SF1023, dissipation factor decreased notably, which are be very beneficial for antenna design and application. At the same time, other physical properties (such as tensile, flexural and HDT) were maintained at similar level compared to the control sample.

TABLE 6
Comparison of formulation and mechanical properties based on DX11354X

| | Item | | | | | |
|---|---|---|---|---|---|---|
| S. No. | code | Item Description | Unit | Control | SFR100 | SF1023 |
| 1 | C023A | 100 grade PCP | % | 30.91 | 30.45 | 30.45 |
| 2 | C017 | PCP 1300 | % | 30.91 | 30.45 | 30.45 |
| 3 | C9030P | 20% PC/Siloxane Copolymer, PCP | % | 15 | 15 | 15 |
| | | endcapped | | | | |
| 4 | C9030T | Transparent PC-Siloxane co- | % | 10 | 10 | 10 |
| | | polymer | | | | |
| 5 | F538 | Pentaerythritol Tetrastearate | % | 0.3 | 0.3 | 0.3 |
| 6 | F174 | Hindered Phenol Stabilizer | % | 0.1 | 0.1 | 0.1 |
| 7 | F207 | Phosphonous Acid Ester, PEPQ | % | 0.1 | 0.1 | 0.1 |
| | | Powder | | | | |
| 8 | F527 | Hindered Phenol Antioxidant | % | 0.08 | 0.08 | 0.08 |
| 9 | F8260 | Mono Zinc Phosphate | % | 0.2 | 0.2 | 0.2 |
| 10 | F293074 | MD1024 | % | 0.2 | 0.12 | 0.12 |
| 11 | F722224 | ADR 4368 (cesa 9900) | % | 0.2 | 0.2 | 0.2 |
| 12 | F593895 | Lazerflair 8840 (Art. No. 1.41055) | % | 3 | 3 | 3 |
| 13 | F502815 | Fine Talc | % | 3 | 3 | 3 |
| 14 | R107C | Coated TiO₂ | % | 6 | 6 | 6 |
| 15 | F433094 | Silicone additive | % | 0 | 1 | 0 |
| 16 | SF1023 | Silicone additive | % | 0 | 0 | 1 |

| | | | | |
|---|---|---|---|---|
| Formulation total | | 100 | 100 | 100 |
| MVR, 300° C., 1.2 kg, 360 sec | cm³/10 min | 35.1 | 22.9 | 20.7 |
| Density, (gram/cubic centimeter) | g/cm³ | 1.28 | 1.27 | 1.28 |
| Notched Impact Strength. 23° C. (Joule per meter) | J/m | 763 | 933 | 859 |
| Notched Impact Strength. −20° C. | J/m | 246 | 795 | 709 |
| HDT, 1.82 Mpa, 3.2 mm (MPa, megaPascal; | ° C. | 124 | 123 | 122 |
| mm, millimeter) | | | | |
| Flexural Modulus | MPa | 2420 | 2310 | 2300 |
| Flexural Strength @ Yield | MPa | 89 | 84 | 84 |
| Modulus of Basicity | MPa | 2547 | 2399 | 2371 |
| Stress at Yield | MPa | 56 | 53 | 54 |
| Stress at Break | MPa | 46 | 50 | 47 |
| Elongation at Break | % | 50 | 74 | 76 |
| Dielectric Constant, 1.1 GigaHertz (GHz) | | 3.03 | 3.01 | 3.03 |
| Dissipation Factor, 1.1 GigaHertz (GHz) | | 0.0069 | 0.0057 | 0.0058 |

As can be seen from the Table 7 below, core grade DX11354 was taken as control sample. Again, with the addition of 1% SFR100 or SF1023, both room temperature and low temperature notched impact strength arrived at pretty high level. Similarly, the dissipation factor was also decreased from 0.0065 to 0.0057-0.0058, which will benefit MP antenna application.

TABLE 7
Comparison of formulation and mechanical properties based on DX11354X

| | Item | | | | | |
|---|---|---|---|---|---|---|
| S. No. | Code | Item Description | Unit | Control | SFR100 | SF1023 |
| 1 | C023A | 100 grade PCP | % | 37.46 | 36.96 | 36.96 |
| 2 | C017 | PCP 1300 | % | 37.46 | 36.96 | 36.96 |
| 3 | C9030P | 20% PC/Siloxane Copolymer, PCP | % | 10 | 10 | 10 |
| | | endcapped | | | | |
| 4 | C9030T | Transparent PC-Siloxane co- | % | 5 | 5 | 5 |
| | | polymer | | | | |
| 5 | F542 | Phosphite Stabilizer | % | 0.06 | 0.06 | 0.06 |
| 6 | F174 | Hindered Phenol Stabilizer | % | 0.1 | 0.1 | 0.1 |
| 7 | F528 | 2-(2′ Hydroxy-5-T-Octylphenyl)- | % | 0.12 | 0.12 | 0.12 |
| | | Benzotriazole | | | | |
| 8 | F8260 | Mono Zinc Phosphate | % | 0.2 | 0.2 | 0.2 |
| 9 | F722224 | ADR 4368 (cesa 9900) | % | 0.2 | 0.2 | 0.2 |
| 10 | F293074 | MD1024 | % | 0.1 | 0.1 | 0.1 |
| 11 | F594825 | Shepherd Black 1G | | 6 | 6 | 6 |
| 12 | F502815 | Fine Talc | % | 3 | 3 | 3 |
| 13 | F538 | Pentaerythritol Tetrastearate | % | 0.3 | 0.3 | 0.3 |
| 14 | F433094 | Silicone additive | % | 0 | 1 | 0 |
| 15 | SF1023 | Silicone additive | % | 0 | 0 | 1 |

| | | | | |
|---|---|---|---|---|
| Formulation total | | 100 | 100 | 100 |
| MVR, 300° C., 1.2 kg, 360 sec | cm³/10 min | 13 | 12.2 | 13.1 |
| MVR, 300° C., 1.2 kg, 1080 sec | cm³/10 min | 18.6 | 17.3 | 17.9 |
| Density | g/cc | 1.26 | 1.26 | 1.27 |
| Notched Impact Strength. 23° C. | J/m | 748 | 884 | 845 |
| Notched Impact Strength. −20° C. | J/m | 309 | 542 | 634 |
| HDT, 1.82 Mpa, 3.2 mm | ° C. | 122 | 123 | 121 |
| Flexural Modulus | MPa | 2510 | 2450 | 2440 |
| Flexural Strength @ Yield | MPa | 89 | 87 | 87 |
| Modulus of Basicity | MPa | 2518 | 2465 | 2467 |
| Stress at Yield | MPa | 57 | 56 | 56 |
| Stress at Break | MPa | 55 | 54 | 57 |
| Elongation at Break | % | 78 | 80 | 89 |
| Dielectric Constant, 1.1 GHz | | 2.9 | 2.89 | 2.90 |
| Dissipation Factor, 1.1 GHz | | 0.0065 | 0.0057 | 0.0058 |

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A thermoplastic composition comprising:
(a) at least one polycarbonate polymer, present in an amount in a range of from about 20 wt % to about 80 wt %, relative to the weight of the entire composition;
(b) at least one polysiloxane-polycarbonate copolymer, present in an amount in a range of from about 5 wt % to about 30 wt %, relative to the weight of the entire composition;
(c) at least one laser direct structuring additive, present in an amount in a range of from about 1 wt % to about 20 wt %, relative to the weight of the entire composition; and
(d) at least one oligomeric siloxane additive, present in an amount in a range of from above 0 wt % to about 10 wt %, relative to the weight of the entire composition.

2. The thermoplastic composition of claim 1, comprising a first and second polysiloxane-polycarbonate copolymer present in a ratio of first to second in a range of from 2:5 to 1:1, wherein the first polysiloxane-polycarbonate copolymer comprises about 16 to about 24 wt % polysiloxane, relative to the entire weight of the first polysiloxane-polycarbonate copolymer and the second polysiloxane-polycarbonate copolymer comprises about 4 to about 10 wt % polysiloxane, relative to the entire weight of the second polysiloxane-polycarbonate copolymer

3. The thermoplastic composition of claim 1, wherein the at least one oligomeric siloxane additive is present in an amount in a range of from about 0.1 wt % to about 5 wt %.

4. The thermoplastic composition of claim 1, wherein at least one of the polycarbonate polymer is a bisphenol A polycarbonate polymer or a blend of at least two different bisphenol A polycarbonates.

5. The thermoplastic composition of claim 1, wherein at least one of the polysiloxane-polycarbonate copolymers comprises siloxane in a range of from 10 wt % to about 20 wt %, relative to the total weight of the polysiloxane-polycarbonate copolymer.

6. The thermoplastic composition of claim 1, wherein at least one of the laser direct structuring additives comprises a heavy metal mixture oxide spinel, a copper salt, or a combination thereof.

7. The thermoplastic composition of claim 1, wherein at least one of the oligomeric siloxane additives comprises a polyamino-polysiloxane, a polymethyl-polysiloxane or a polyphenyl-polysiloxane having a plurality of repeating units:

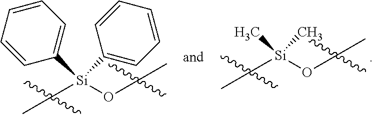

8. The thermoplastic composition of claim 1, wherein at least one of the oligomeric siloxane additives is a hydroxy terminated silicone fluid or is terminated by trimethyl silyl groups.

9. The thermoplastic composition of claim 1, further comprising one or more optional additives selected from an antioxidant, flame retardant, inorganic filler, and stabilizer.

10. The thermoplastic composition of claim 1, exhibiting one or more of the following properties:
(a) a Notched Impact Strength at 23° C. that is at least 800 J/m, at least 850 J/m, or at least about 900 J/m (up to about 1100 J/m), when tested according to ASTM D256;
(b) a Notched Impact Strength at −20° C. that is at least 400 J/m, at least 500 J/m, at least 600 J/m, or at least about 700 J/m (up to about 800 J/m), when tested according to ASTM D256;
(c) a Notched Impact Strength at either −20° C. or 23° C. or both −20° C. and 23° C. that is at least 10% higher than the Notched Impact Strength of the otherwise identical material but lacking the at least one oligomeric siloxane additive, when tested under the same conditions according to ASTM D256;
(d) a dissipation factor at 1.1 GHz that is less than 0.006 or less than 0.0058, when tested according to ASTM D150; or
(e) a dissipation factor at 1.1 GHz that is at least 10% less than the dissipation factor at 1.1 GHz of the otherwise identical material but lacking the at least one oligomeric siloxane additive, when tested under the same conditions according to ASTM D150.

11. The thermoplastic composition of claim 1 comprising:
(a) at least one bisphenol A polycarbonate polymer, present in an amount in a range of from about 70 wt % to about 80 wt %, relative to the weight of the entire composition;
(b) at least one polysiloxane-polycarbonate copolymer, present in an amount in a range of from about 5 wt % to about 15 wt %, relative to the weight of the entire composition;
(c) at least one laser direct structuring additive, present in an amount in a range of from about 4 wt % to about 10 wt %, relative to the weight of the entire composition; and
(d) at least one oligomeric siloxane additive, present in an amount in a range of from 0.1 wt % to about 2 wt %, relative to the weight of the entire composition.

12. The thermoplastic composition of claim 1, comprising a first and second polysiloxane-polycarbonate copolymer present in a ratio of first to second in a range of from 2:5 to 1:1, wherein the first polysiloxane-polycarbonate copolymer comprises about 16 to about 24 wt % polysiloxane, relative to the entire weight of the first polysiloxane-polycarbonate copolymer and the second polysiloxane-polycarbonate copolymer comprises about 4 to about 10 wt % polysiloxane, relative to the entire weight of the second polysiloxane-polycarbonate copolymer.

13. The thermoplastic composition claim 12, further comprising a plated surface.

14. A method for making a thermoplastic composition comprising: forming a blend composition comprising
(a) at least one polycarbonate polymer present in an amount in a range of from about 20 wt % to about 80 wt %,
(b) at least one polysiloxane-polycarbonate copolymer present in an amount in a range of from about 5 wt % to about 30 wt %,
(c) at least one laser direct structuring additive present in an amount in a range of from about 1 wt % to about 20 wt %, and
(d) at least one oligomeric siloxane additive present in an amount in a range of from above 0 wt % to about 10 wt %;
forming a molded part from the formed blend composition;
subjecting the molded part to a laser direct structuring process; and
plating the laser structured molded composition,
wherein all weight percentages are provided relative to the weight of the entire composition.

15. (canceled)
